(19) United States
(12) Patent Application Publication
(10) Pub. No.: US 2014/0047334 A1
(43) Pub. Date: Feb. 13, 2014

(54) COMPUTER APPLICATION LEARNING SOLUTION

(71) Applicant: Arnaud Nouard, Huisonlongueville (FR)

(72) Inventor: Arnaud Nouard, Huisonlongueville (FR)

(73) Assignee: SAP AG, Walldorf (DE)

(21) Appl. No.: 13/570,662

(22) Filed: Aug. 9, 2012

(51) Int. Cl. G06F 3/048

(52) U.S. Cl. 715/705; 715/764; 715/760

(57) ABSTRACT

A computer-implemented method is performed by causing at least one processor to by execute instructions recorded on a computer-readable storage medium. The computer-implemented method includes interfacing an informative effects engine with a computer application, detecting an operation of a select feature or function of the computer application on a user-application interface, and in response to the detection, presenting a tutorial with one or more informative effects related to the select feature or function of the computer application on the user-application interface.

### BACKGROUND

Driven by rapid increases in computing power and network connectivity modern computer application or software products, irrespective of whether they are for home, small office, business or enterprise use, are made to provide comprehensive functionality for increasingly intricate tasks or processes. As a result, the computer application products tend to be large, complex and not easy to use. The computer application products may be accompanied by extensive technical documentation and large manuals, which in practice are often too complex or arcane for end-users of the products to peruse or understand. End-users need extensive (and expensive) training to be able to use these complex application products. Organizations and enterprises may conduct introductory classroom training to introduce a complex computer application (e.g., a business application which help build content such as reports) to its end-user workforce. However, end-users face steep learning curves, and in practice there may be too much detail in the computer application to present in introductory classroom training sessions and for the end-users to absorb in a short time. Invariably in actual use, end-users encounter difficulties and situations in which they do not know how to use features or components of the computer application. Adoption of the complex computer application by the end-users is a slow learning process.

Consideration is now being given to ways imparting knowledge about features and functions of a computer application to end-users.

### SUMMARY

In one general aspect, a computer-based system includes a processor, a computer application, and an informative effects engine coupled to the computer application. The informative effects engine has one or more scripts for displaying pre-defined informative effects for one or more features or functions of the computer application on a user-application interface. When the processor detects use of the computer application on the user-application interface, the informative effects engine makes an informative presentation on select features and functions of the computer application using the pre-defined informative effects on the user-application interface. The informative effects, which can be static effects or dynamic movie effects, may include, for example, audio effects, visual effects, textual effects and graphical effects.

In an aspect, the computer-based system detects a launch of the computer application that brings up a starting screen or other screen of the computer application on the user-application interface, and presents an overview tutorial of features and functions of the application with informative effects sequentially highlighting one or more parts of the application on the user-application interface. In another aspect, the computer-based system detects user-operation of a specific feature or function of the computer application, and makes a contextual presentation with one or more informative effects highlighting the specific feature or function of the computer application used on the user-application interface.

In a general aspect, a computer-implemented method is performed by causing at least one processor to execute instructions recorded on a computer-readable storage medium. The computer-implemented method includes interfacing an informative effects engine with a computer application, detecting a user-operation of a select feature or function of the computer application on a user-application interface, and, in response to the detection, presenting a tutorial with one or more informative effects related to the select feature or function of the computer application on the user-application interface.

In a general aspect, a computer-program product embodied in a non-transitory computer-readable medium includes executable code, which when executed interfaces an informative effects engine with a computer application, detects a user-operation of a select feature or function of the computer application on a user-application interface, and in response to the detection, presents a tutorial with one or more informative effects related to the select feature or function of the computer application on the user-application interface.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustration of an example system for implementing a learning solution for a subject computer application, in accordance with the principles of the disclosure herein.

FIGS. 2A and 2B are schematic illustrations of an example tutorial or introductory informative presentation made by the system of FIG. 1 in a static scenario to highlight and describe select features and functions of the subject computer application on a user-application interface, in accordance with the principles of the disclosure herein.

FIGS. 3A and 3B are schematic illustrations of an example contextual scenario informative presentation made by the system of FIG. 1 in a dynamic or contextual scenario to highlight data manipulation features and capabilities of the subject computer application on a user-application interface, in accordance with principles of the disclosure herein.

FIG. 4 is a sequence diagram illustrating interactions between an informative effects engine and a computer application, in accordance with the principles of the disclosure herein.

FIG. 5 is a flow diagram illustration of an example computer-implemented method for implementing a learning solution to provide end-users with informative effects highlighting features and functions of a computer application toward increasing the end-users' knowledge and understanding of the computer application, in accordance with the principles of the disclosure herein.

### DETAILED DESCRIPTION

A computer-based “learning” solution provides end-users with informative effects highlighting and describing features and functions of a computer application toward increasing the end-users' knowledge and understanding of the computer application. The informative effects may be static and dynamic movie effects, including, for example, audio, visual, textual and/or graphical effects. The informative effects may be linked or associated with particular features and functions of the computer application. The informative effects may be presented to the end-users in static scenarios (e.g., when a screen or page of the application is displayed) independent of user operation of the computer application, and also under contextual scenarios in which the particular features and functions (e.g., in a displayed screen or page) of the computer application are being actually used by an end-user. The learning solution may help an end-user contextually learn the computer application in operation at his or her own pace at the right time and the right place.

The learning solution may be deployed in conjunction with a subject computer application, which may be any one of a number different available types of computer applications that include, for example, applications for home or small office use such as home accounting software, and office suites for word processing, spreadsheets, presentations, graphics, and databases, applications for medium size office or business use such as applications in the fields of accounting, groupware, customer relationship management, human resources software, outsourcing relationship management, loan origination software, shopping cart software, and field service software, and applications for large businesses or enterprise use such as applications in the fields of enterprise resource planning, enterprise content management (ECM), business process management (BPM) and product lifecycle management, etc.

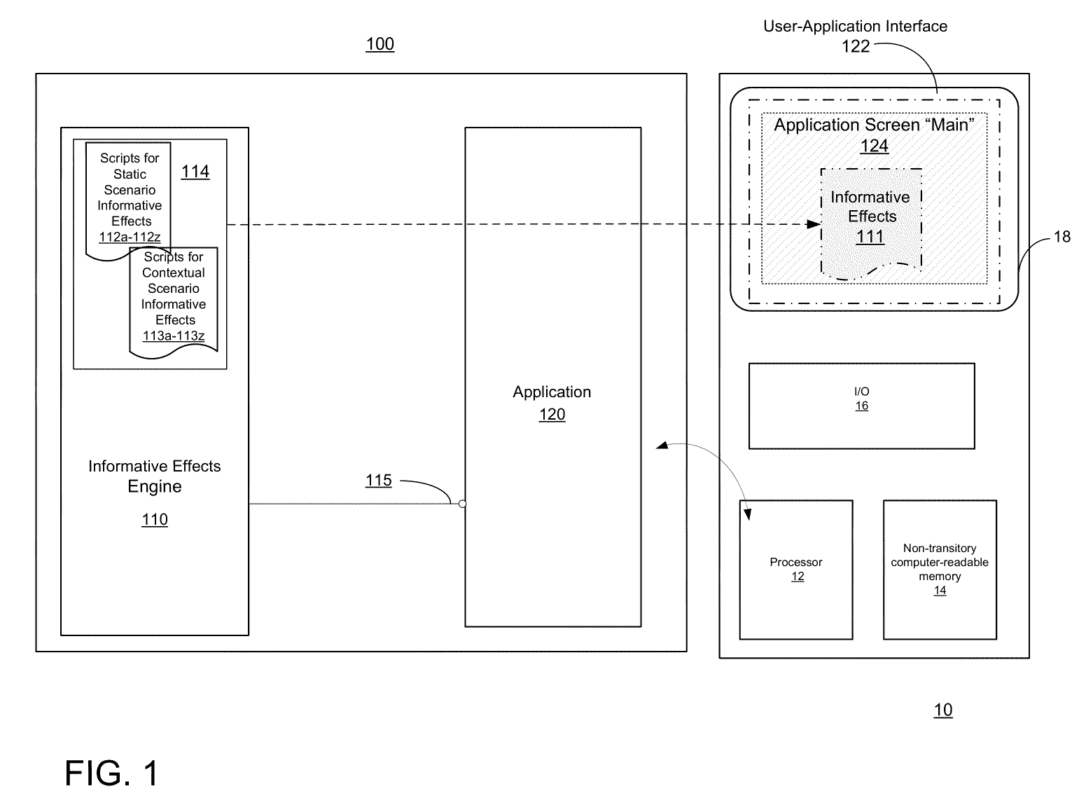

FIG. 1 shows an example system 100 that may be used to implement a learning solution for a subject computer application 120, in accordance with the principles of the disclosure herein.

System 100 may include an informative effects engine 110, which is coupled to an example subject computer application 120 through one or more interprocess interfaces 115. Code written to carry out functions of informative effects engine 110 may be integrated with the code of subject computer application 120. Informative effects engine 110 may be conveniently integrated with subject computer application 120, for example, as an add-in or plugin feature. From an end-user perspective, informative effects engine 110 may be a built-in system feature or an optional user-activable feature of subject computer application 120.

System 100, like subject computer application 120 by itself, may be deployed on a stand-alone computer or distributed on one or more physical or virtual machines in a computer network, which may be accessible to end-users via one or more user devices (e.g., laptops, netbooks, desktops, dumb terminals, smart phone, etc.) that may be wire or wirelessly linked to system 100. FIG. 1 shows system 100 hosted, for example, on a computer 10, which includes a processor 12, a non-transitory computer readable memory 14, an/ I/O 16 and a display screen 18.

System 100 may include a user-application interface 122, which may be displayed, for example, on display screen 18 of computer 10. An end-user may be able to operate or access features and functions of subject computer application 120 through user-application interface 122. An end-user may be able, for example, to query, modify, input or enter data and view results via user-application interface 122. Further in system 100, informative effects engine 110 may present informative effects related to operation of subject computer application 120 to the end-user through user-application interface 122.

Informative effects engine 110 may present the informative effects to the end-user under different scenarios in the operation of subject computer application 120. The different scenarios may cover occurrence of specific application status and/or specific workflows or actual user actions in the operation of subject computer application 120.

The specific application status and specific workflows or actual user actions in the operation of subject computer application 120 may correspond to defined graphical objects displayed on user-application interface 122. The defined graphical objects may be associated with respective graphical object identifiers (e.g., “Object_ID”). For example, a page or screen 124 of subject computer application 120 displayed on user-application interface 122 may be associated with a unique object identifier (e.g., Screen_ID). Further, for example, each workflow or actual user action on user-application interface 122 may be associated with a workflow graphical object having its own unique Object_ID.

Processor 12/subject computer application 120 may recognize graphical objects as they are dynamically displayed on user-application interface 122 by detecting their associated Object_IDs. System 100 may accordingly determine a current or live status of the application (e.g., a displayed screen or page) and identify specific workflows or actual user actions in subject computer application 120 as they occur. Based on the dynamically detected object identifiers, informative effects engine 110 may present timely informative effects (e.g., Informative Effects 111) related to the current application status, or specific workflows or actual user actions to the end user.

An example informative effects engine 110 may present informative effects for subject computer application 120 in two types of scenarios—static and contextual. A static scenario may relate to characteristics or aspects of subject computer application 120 that may be valid generally, independent of specific workflows or actual end-user actions that may occur in operation of subject computer application 120. Static scenario informative effects (e.g., static scenario informative effects 112a-112z) may address general user questions (e.g., “what all can I do on the main screen?” or “what can I do on this spreadsheet page?”) about subject computer application 120, which do not depend on an actual workflow initiated by an end-user. In contrast, contextual scenario informative effects (e.g., contextual informative effects 113a-113z) may address user questions (e.g., “how do I recover the particular text I jus deleted?” or “how do I merge data in these two columns?”) related to specific workflows or actual user actions within application screens or pages in the operation of subject computer application 120.

A number of model contextual scenarios of workflows and user actions in the operation of subject computer application 120 may be developed based, for example, on analysis of the structure and functions of subject computer application 120 and potential or probable user actions. In system 100, workflows or sequences of one or more user actions corresponding to the model contextual scenarios may be associated with respective object identifiers. Occurrence of a specific workflow or user action in actual operation or runtime of the subject computer application may be recognized by processor 12/subject computer application 120 upon detection of the corresponding object identifier.

Informative effects engine 110 may include or be coupled to a store 114 of scripts for pre-defined informative effects including, for example, static scenario informative effects (e.g., static scenario informative effects 112a-112z) and/or contextual informative effects (e.g., contextual informative effects 113a-113z). As noted previously, the informative effects may include any combination of audio, visual, textual and graphical elements in a static format or a dynamic movie-like format. The stored scripts for the pre-defined static and contextual informative effects may have been respectively prepared (e.g., by an application developer) for a selected number of model static and contextual scenarios that may occur in user-operation of the subject computer application. Each of the selected scenarios may be associated with a respective object identifier. The scripts for informative effects may be prepared, for example, as XML files.

In an example implementation, system 100 may be configured to provide a “tutorial” presentation describing features and capabilities of subject computer application 120 in a static scenario, for example, when the latter is first launched or activated by an end-user to bring up a starting screen (e.g., main screen 124) or other screen or page of the application on user-application interface 122. The tutorial presentation may include one or more of pre-defined static scenario informative effects (e.g., static scenario informative effects 112a-112z) available to system 100. A screen identification (e.g., Screen_ID=“Main”) associated with the main screen of subject computer application may, for example, be detected by system 100 at runtime when subject computer application 120 is first launched. System 100 may use the detection of the screen identification Screen_ID as a trigger to launch the tutorial presentation on user-application interface 122 in the static scenario corresponding to the display of the main screen.

In an example tutorial presentation, system 100 may, for example, visually highlight selected parts of the application and publish textual information describing the selected parts. The tutorial presentation may sequentially move from one selected part to another selected part to give the end-user an overview of subject computer application 120. The presentation may include audio-visual effects such as zooming, scrolling, fade-outs and other movie special effects to draw the end-user's attention to the selected parts of the application and the accompanying informative textual descriptions.

### Example Static Scenario Informative Presentation

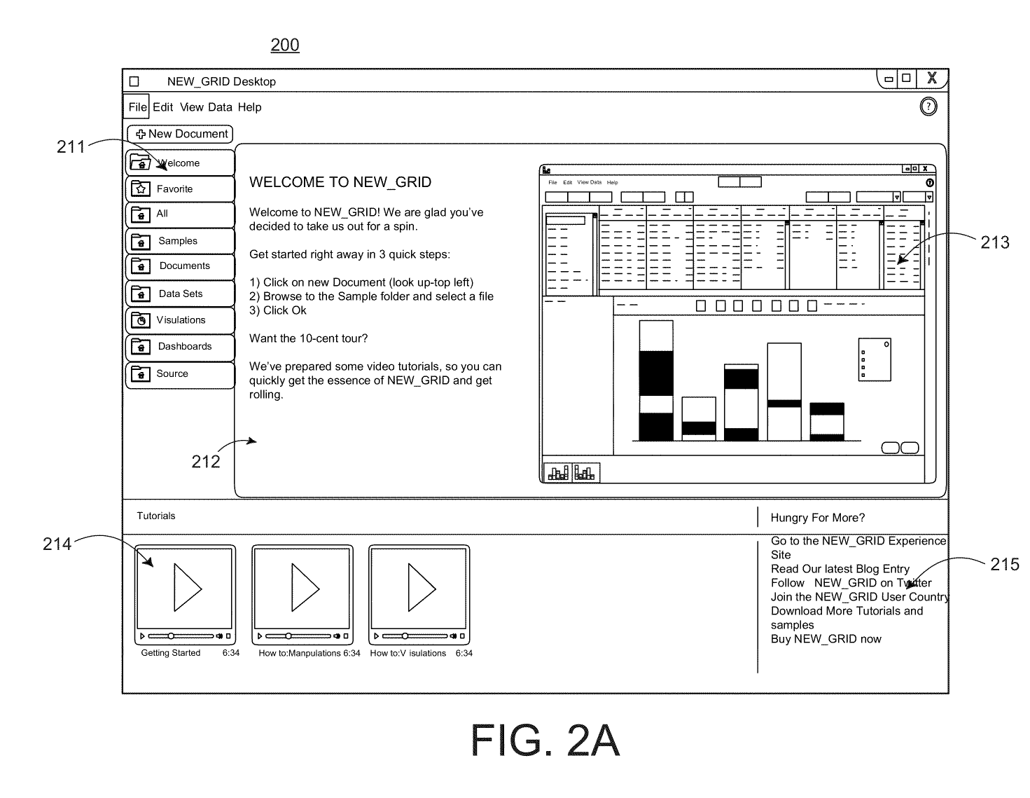

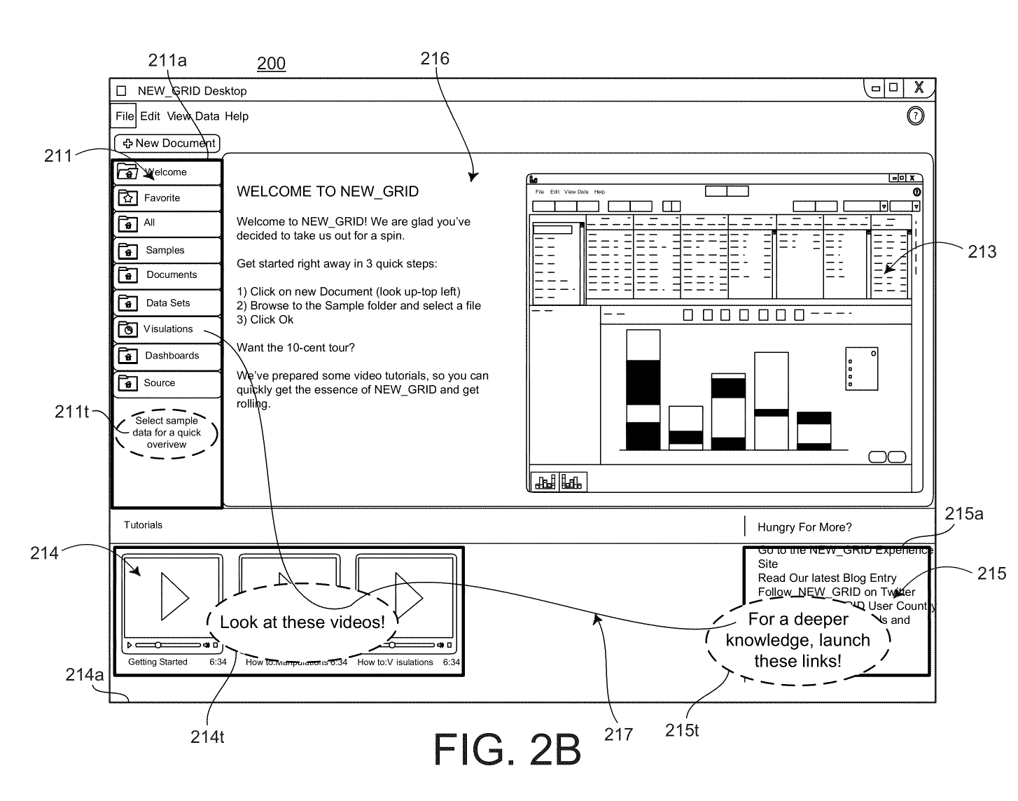

FIGS. 2A and 2B relate to an example tutorial or introductory informative presentation made by system 100 in a static scenario to highlight and describe select features and functions of a subject computer application (e.g., application “NEW_GRIDS”) on user-application interface 122. The highlighted features and functions in the introductory informative presentation may have been selected to give the end-user an overview of the use or operation of application NEW_GRIDS.

FIG. 2A shows an example “Welcome” page of a main starting screen 200 of application NEW_GRIDS. Main starting screen 200 may be displayed on the user-application interface when application NEW_GRIDS is first launched. Main starting screen 200, which may be associated with an object identifier (e.g., Screen_ID=“MAIN”), may include one or more graphical objects representing features and functions of application NEW_GRIDS. The graphical objects in the displayed screen may include, for example, page links 211 (e.g., “Welcome”, “Favorites”, “All”, “Samples”, “Documents” “Data Sets” “Visualization”, “Dashboard” and “Sources”) that link to various pages of the application, introductory welcoming text 212 including a depiction of a sample working page 213 of application NEW_GRIDS, links to video tutorials 214, and links to further resources 215 that may be helpful to the end-user in exploring features of application NEW_GRIDS.

An end-user may, for example, activate the Visualization link in page links 211 to initiate launch of the introductory informative presentation. System 100 may determine or confirm the presence of main starting screen 200 by detecting the corresponding object identifier Screen-ID=“MAIN” at runtime. System 100 may accordingly launch the introductory informative presentation with various visual effects highlighting and describing select features and functions of application NEW_GRIDS (e.g., page links 211, links to video tutorials 214, and links to further resources 215), which may have been selected to give the end-user an overview of application NEW_GRIDS. The introductory informative presentation may display the various visual effects for the select features and functions in a suitable time sequence to highlight and describe the graphical objects corresponding to the select features and functions of application NEW_GRIDS one-by-one.

FIG. 2B shows examples of visual effects used in the introductory informative presentation to highlight the select features and functions/graphical objects. The visual effects in the introductory presentation may include placing the selected graphical objects in bold-frame highlight boxes (e.g., boxes 211a, 214a, and 215a, respectively) to draw the user's attention to the features and functions of application NEW_GRIDS that are represented by the selected graphical objects. The remainder objects and background 216 in main screen 200 may be grayed or faded out to increase visual contrast with the highlight boxes. Further, informative textual descriptions may be overlaid on the highlight boxes 211a, 214a, and 215a. The informative textual descriptions (e.g., 211t “select sample data for a quick overview,” 214t “look at these videos”, and 215t “for a deeper knowledge launch these links”) may guide the user through the introductory informative presentation.

It will be understood that in FIG. 2B, three highlight boxes 211a, 214a, and 215a (and overlaid textual descriptions 211t, 214t and 215t) are shown as being displayed together on main screen 200 in the introductory informative presentation only for economy in the number of figures included herein. In practice, highlight boxes 211a, 214a, and 215a need not be displayed together at the same time in the introductory informative presentation. They may be displayed one-by-one, for example, in a time sequence, which is schematically represented by path 117.

The introductory informative presentation may be prepared or authored (e.g., by an application developer) by first selecting one or more suitable graphical objects for the presentation, and creating a script describing the behavior or effects to be displayed at runtime for the selected graphical objects. The script may have a semi-structured, semi-descriptive data output or other kind of human-machine readable output (e.g., an XML file). A snippet of an example XML file for displaying informative textual descriptions 213t, 214t and 215t (FIG. 2D) at runtime may be as follows:
<KAISM app=“My Application Name”>
<SCENARIO id=“Introduction” type=“static” SCREEN_ID=“Main”>
<UI id=“ID MainTree” DURATION=“5” TEXT=“Select sample data here!” I>
<UI id=“ID DemoVideo” DURATION=“10” TEXT=“Look at these videos!” I>
<UI id=“ID Links” DURATION=“30” TEXT=“For a deeper knowledge launch these links!” I>

It will be noted that each of the three graphical objects selected for the introductory presentation (e.g., page links 211, links to video tutorials 214, and links to further resources 215) may be associated with a respective object identifier (e.g., “ID_MainTree”, “ID_DemoVideo”, and “ID_Links”, respectively). The object identifiers may allow recognition of occurrences of these graphical objects at runtime and sequencing of the related behavior and effects displayed in introductory informative presentation as shown, for example, in the foregoing snippet of the example XML file.

It will be noted that creating scripts or other kind of readable output for the introductory informative presentation, for example, as XML files, avoids having generated code as output. The XML files for the introductory informative presentation may be written by hand or by using a automation tool, which may be similar to available tools for UI automation that are based on testable association of UI components with unique object IDs.

FIGS. 2A and 2B also represent example selection steps that an application developer may take for preparing a script for the introductory informative presentation. FIG. 2A shows selection of main starting screen 200 as a base for introductory presentation 200. Main starting screen 200 may be selected by its SCREEN_ID name “Main,” as shown, for example, in the foregoing snippet of the XML file as XML element:
<SCENARIO id=“Introduction” type=“static” SCREEN_ID=“Main”>.

Next, FIG. 2B shows selection of three graphical objects, which are associated with respective object IDs (e.g., “ID_MainTree”, “ID_DemoVideo”, “ID_Links”), to be highlighted in the introductory informative presentation. FIG. 2B also shows a selection of visual effects (e.g., graying or fading of other screen objects and background) to highlight the three selected three graphical objects in the introductory informative presentation. FIG. 2B further shows selection of a time sequence or path (path 117) for highlighting the three selected three graphical objects one-by-one in the introductory informative presentation. Lastly, FIG. 2B shows the informative text that will be applied at runtime to each of the three graphical objects in an overlay mode, for example, by the following elements in the foregoing snippet of the example XML file:

<UI id = “ID_MainTree” DURATION = “5” TEXT = “Select sample
data here!” />
<UI id = “ID_DemoVideo” DURATION = “10” TEXT = “Look at these
videos!” />
<UI id = “ID_Links” DURATION = “10” TEXT = “For a deeper
knowledge launch these links!” />.

### Example Dynamic or Contextual Scenario Informative Presentation

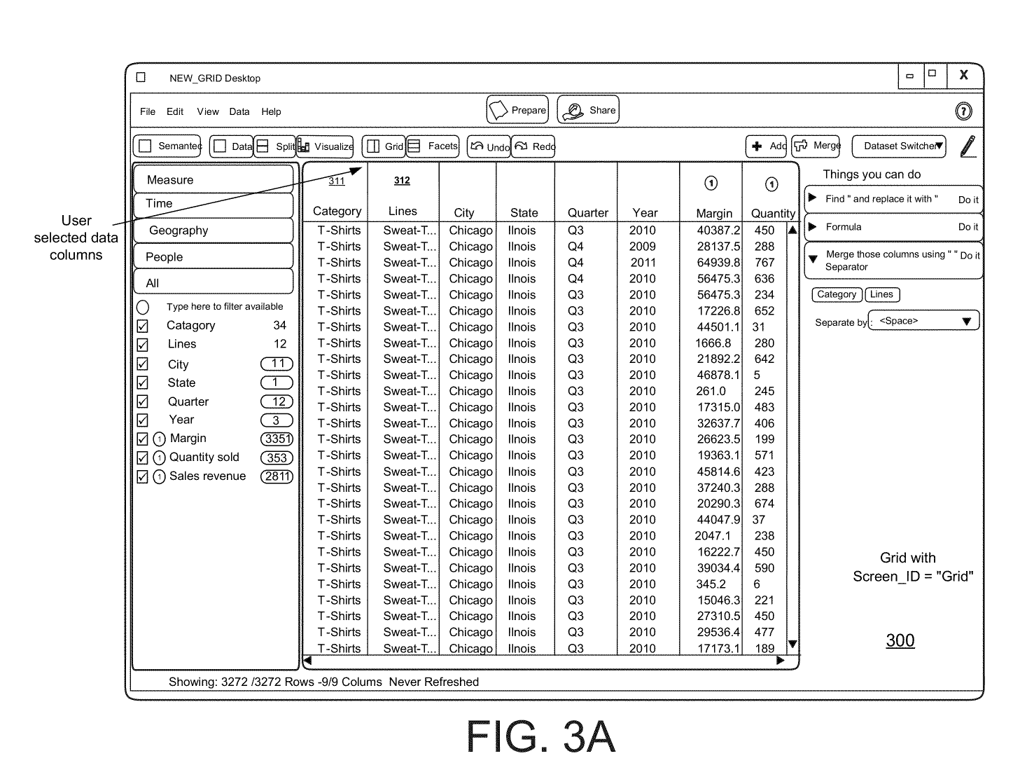

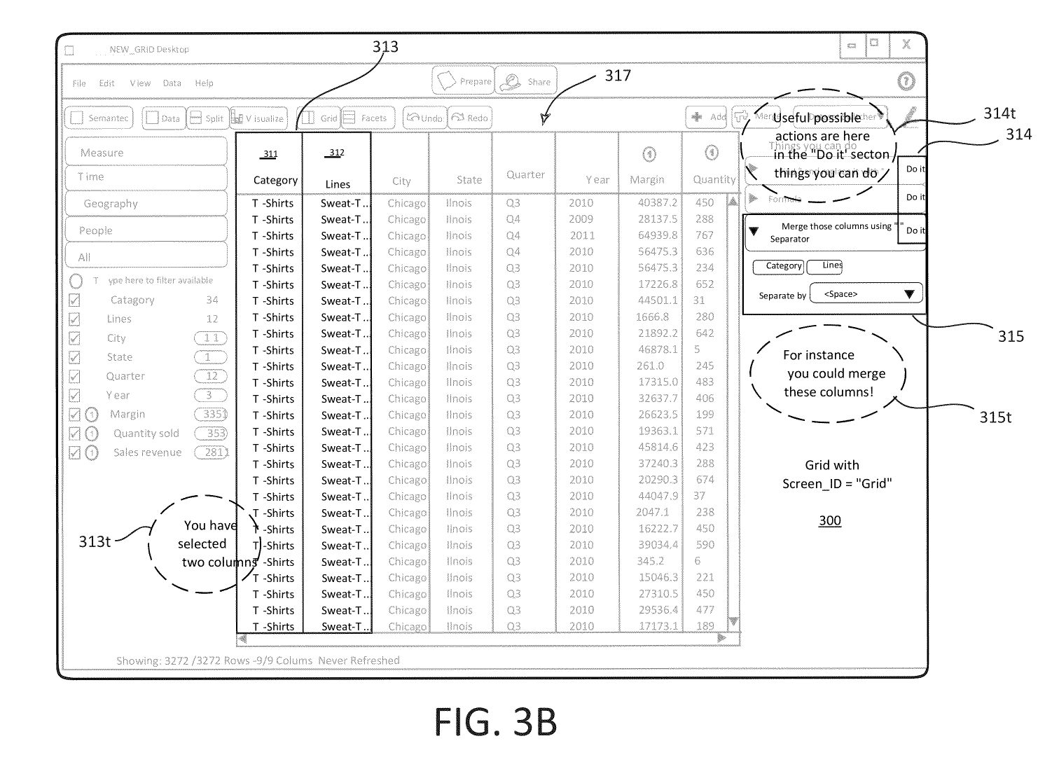

FIGS. 3A and 3B relate to an example contextual scenario informative presentation which may be made by system 100 in a dynamic or contextual scenario to highlight, for example, data manipulation features and capabilities of a subject computer application on user-application interface 122. A context for the informative presentation may arise from a user action, for example, in a data spreadsheet page (e.g., grid 300 with Screen_ID=“Grid”) in application NEW_GRIDS. FIG. 3A depicts, for example, a user action selecting two data columns 311 and 312 (“Category” and “Lines”, respectively) of grid 300 in application NEW_GRIDS.

An application developer may prepare a script for a contextual informative presentation (e.g., under a Scenario ID=“DataManipulation”) in response to the user action selecting the two data columns. The application developer may prepare the script for the contextual informative presentation in a manner that is similar to preparing a script for an introductory informative presentation in a static scenario, which was described above, for example, with reference to FIGS. 2A and 2B. FIG. 3A shows selection of screen 300 having a Screen_ID of “Grid” as a base for the contextual informative presentation. FIG. 3B shows selection of one or more graphical objects to be included in the presentation. The graphical objects included in the presentation may include the graphical object representing the specific user action and other related objects that, for example, illustrate application capabilities and options for the specific user action. The selected graphical objects may, for example, include a two-column object representation 313 of the two user-selected columns 311 and 312, and further objects 314 and 315 displayed under a “Things You Can Do” category on grid 300. The selected objects 313, 314, and 315 may be associated with respective object identifiers, for example, two-column object representation 314 may be associated with an object identifier “TwoColumnSelected”. FIG. 3B also shows selection of visual effects (e.g., graying or fading of remainder objects and background 316 of grid 300) that may be used to highlight or contrast each the three selected graphical objects in the contextual informative presentation. FIG. 3B further shows selection of a time sequence or path (e.g., path 317) for highlighting the three selected three graphical objects 313, 314 and 315 one-by-one in the contextual informative presentation, which may be triggered by detection of the object identifier “TwoColumnSelected”. FIG. 3B also shows informative text (313t, 314t and 315t) that the application developer may write to be applied at runtime to each of the three graphical objects in the contextual informative presentation.

A snippet of an example XML file for implementing the foregoing contextual presentation under a Scenario ID=“DataManipulation” may be as follows:

```
<KAISM app =“My Application Name”>
. . .
<SCENARIO id =“DataManipulation” type =“dynamic”
onTrigger =“TwoColumnSelected” SCREEN_ID =“Grid”>
      <UI id =“ID_Grid” DURATION =“10” TEXT =“You have
      selected two columns” />
      <UI id =“ID_RightPane” DURATION =“15” TEXT =“You will
      be able to merge the two columns into a single one by pressing
      this button” />
      ...
</SCENARIO>
</KAISM>.
```

It will be noted that triggering the contextual scenario informative presentation requires detection of the screen identifier “Grid” and also detection of a context trigger i.e. the object identifier “TwoColumnSelected”, associated with the two-column object 313 indicative of the specific user action selecting two data columns 311 and 312. In contrast, triggering a static scenario informative presentation requires detection only of a screen identifier (e.g., screen identifier “Main”) and is independent of application workflows and user actions, as discussed above with reference to FIGS. 2A and 2B. Thus, with renewed reference to FIG. 1, system 100 may be implemented for static scenarios with a declaration of a generic interface 115 between informative effects engine 100 and application 120. However, implementation of system 100 for contextual scenarios may require declarations of contextual scenario-specific interfaces 115 between informative effects engine 100 and application 120. In practice, system 100/effects engine 110 may be coded with a generic part and a specific part for static and contextual scenarios, respectively. The generic part based only the screen-ID trigger, may be coded independent of details of the subject computer application or the UI technology used. In contrast, the specific part, which may be based on various user-action context triggers, may have to be specifically coded for different types of context triggers.

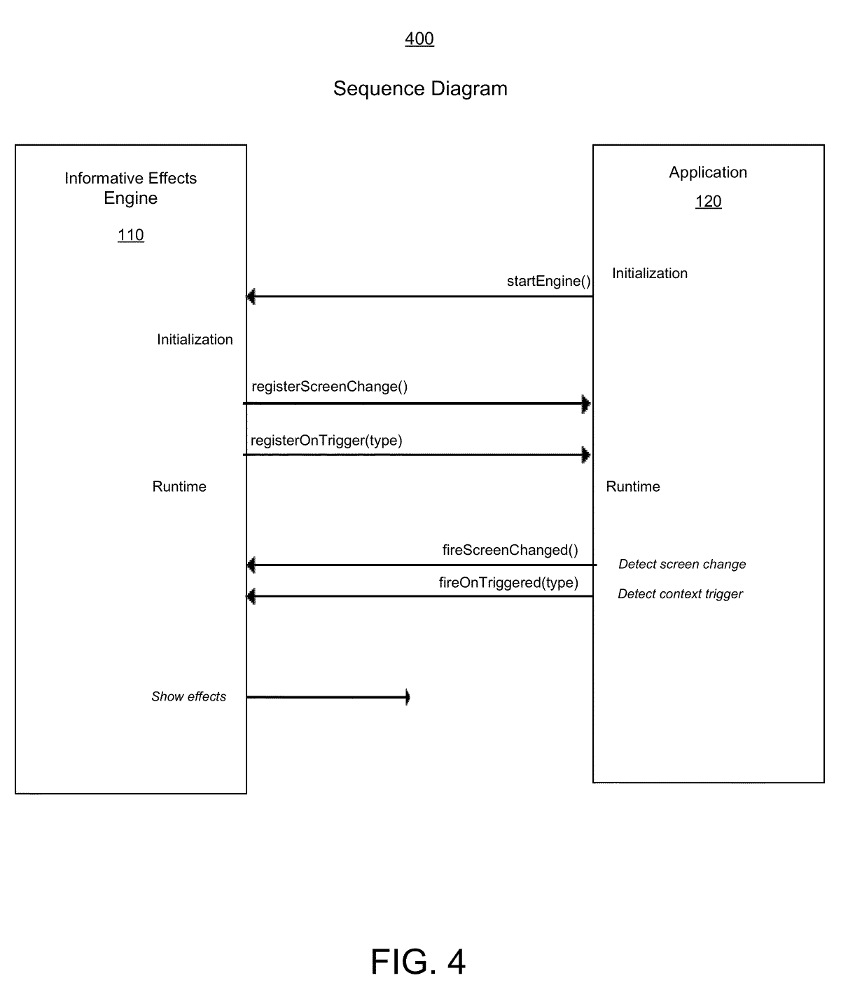

FIG. 4 is a sequence diagram 400 of interactions between informative effects engine 110 and application 120 in an example implementation of system 100. In the example implementation of system 100, application 120 when launched may initialize and start informative effects engine 110 (e.g., using code startEngine). On starting, informative effects engine 110 may initialize by registering screen identifiers and workflow context trigger identifiers for various static and contextual informative presentations with application 120 (e.g., using codes registerScreenChange and registerOnTrigger (type), respectively). At runtime, application 120 may pass any detected screen identifiers (e.g., using code fireScreenChanged) to informative effects engine 110 to trigger a corresponding static scenario informative presentation in application 120. Further in runtime, application 120 may pass any detected workflow context trigger identifiers (e.g., using code fireOnTrigger(Type)) to informative effects engine 110 to trigger a corresponding contextual scenario informative presentation in application 120.

System 100 may be further configured to provide options for an end-user to interrupt, replay or stop an informative presentation being made by effects engine 110. System 100 may, for example, recognize certain user interactions such as mouse moves, keyboard entries or screen button activations as interrupt, replay or stop indicators. Informative effects engine 110 may be configured to accordingly interrupt, replay or stop the informative presentation in response to the certain user interactions. Informative effects engine 110 may seek user confirmation before actually interrupting, replaying or stopping the informative presentation via, for example, a pop-up window.

It will be understood that informative presentations made by informative effects engine 110 may include more varieties of static or movie effects than can be practically represented in two-dimensional figures (e.g., FIGS. 2A-2D and 3A-3D). The movie effects may include a camera “zoom and pan” effect and other types of effects. Different kinds of camera moves or effects may be used depending on the scenario.

In one example presentation, the subject application screen may be static in view. A graphical object included in the presentation may be brought to the front of the view, for example, as a flying window using a smooth acceleration. The graphical object may be held in fixed position for the duration of the presentation. A light scrolling effect may continuously move the graphical object in view. Further, overlaid textual description may be presented with a predefined entrance effect such as a “fly in” on a motion path.

In another example presentation, the entire subject application screen may be zoomed to display a magnified view of selected graphical objects or areas of interest. Each graphical object or area of interest highlighted in the presentation may be brought to the front of the screen view, for example, as a flying window using a smooth acceleration and kept in position for the duration of the presentation related to it. A light scrolling effect may be used to continuously move the graphical object or area in view. Further, overlaid textual description may be presented with a predefined entrance effect such as a fly in following a motion path.

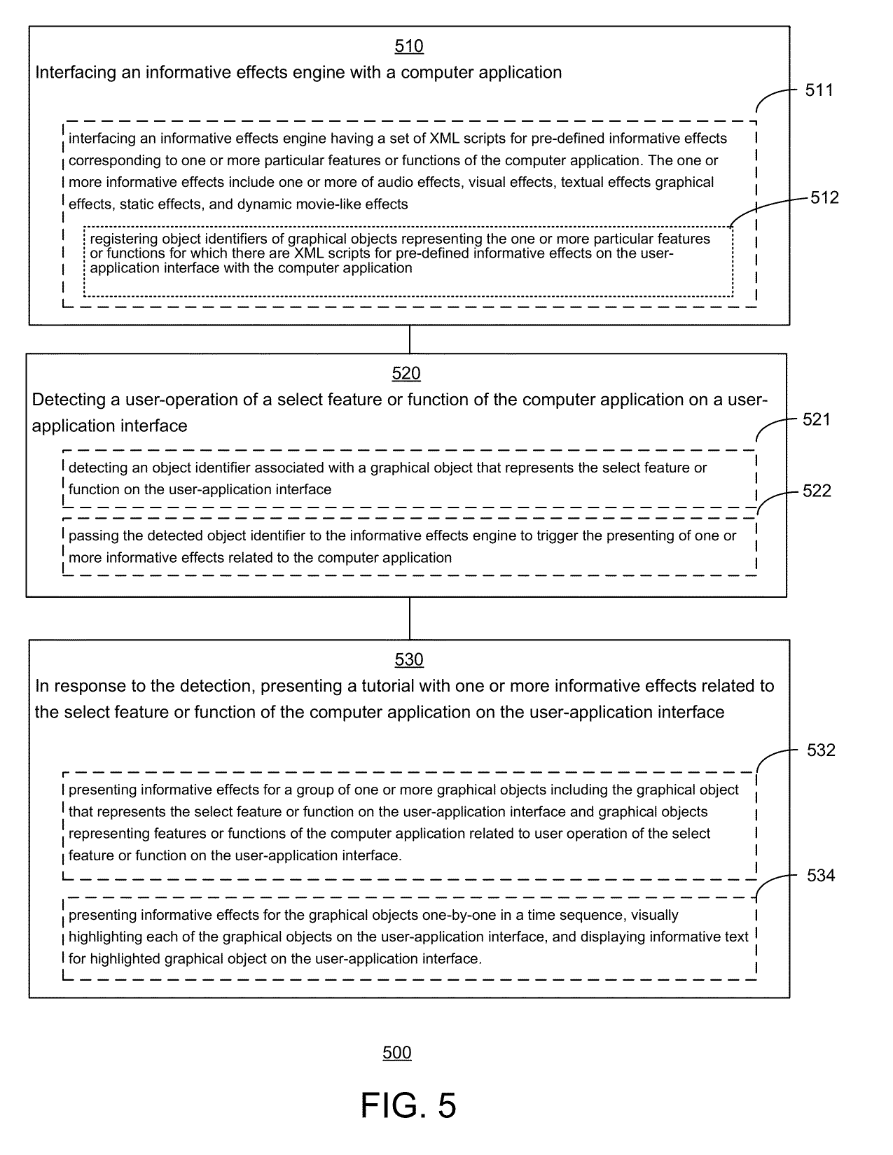

FIG. 5 shows an example computer-implemented method 500 for implementing a learning solution to provide end-users with informative effects highlighting features and functions of a computer application toward increasing the end-users' knowledge and understanding of the computer application. Method 500 can be carried out by having a computer processor execute instructions stored on non-transitory computer readable media.

Method 500 includes interfacing an informative effects engine with the computer application (510), detecting a user-operation of a select feature or function of the computer application on a user-application interface (520), and, in response, presenting a tutorial with one or more informative effects related to the select feature or function of the computer application on the user-application interface (530). The informative effects, which may be static or movie, may, for example, include audio, visual, textual and/or graphical effects.

In method 500, interfacing an informative effects engine with the computer application 510 may involve interfacing an informative effects engine having a set of XML scripts for pre-defined informative effects corresponding to one or more particular features or functions of the computer application (511). The one or more informative effects may include one or more of audio effects, visual effects, textual effects, graphical effects, static effects, and dynamic movie effects. The one or more particular features or functions of the computer application may represented by respective graphical objects, which have unique object identifiers, on the user-application interface. The graphical objects may, for example, include one or more screens or pages of the computer application displayed on the user-application interface. The graphical objects may also, for example, include one or more workflow objects resulting from user actions (i.e. user operation of a feature or function, for example, in a screen or page of the application) on the user-application interface. Interfacing an informative effects engine with the computer application 510 may include registering object identifiers of the graphical objects representing the one or more particular features or functions for which there are XML scripts for pre-defined informative effects on the user-application interface with the computer application (512).

In method 500, detecting an operation of a select feature or function of the computer application on a user-application interface 520 may involve detecting an object identifier associated with a graphical object that represents the select feature or function on the user-application interface (521), and passing the detected object identifier back to the informative effects engine (522) to trigger the presenting of one or more informative effects related to the computer application.

Further in method 500, presenting a tutorial with one or more informative effects related to the select feature or function of the computer application 530 may include presenting informative effects for a group of one or more graphical objects including the graphical object that represents the select feature or function on the user-application interface (531). The group of one or more graphical objects may include additional graphical objects representing features or functions of the computer application that may be related to user operation of the select feature or function on the user-application interface. Presenting informative effects for a group of one or more graphical objects 531 may include presenting informative effects for the graphical objects one-by-one in a time sequence (532) visually highlighting each of the graphical objects on the user-application interface and displaying informative text for highlighted graphical object on the user-application interface.

The various infrastructure, systems, techniques, and methods described herein may be implemented in digital electronic circuitry, or in computer hardware, firmware, software, or in combinations of them. The implementations may be a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-based system comprising:
a processor; and
an informative effects engine having one or more scripts for displaying pre-defined informative effects for one or more features or functions of a computer application on a user-application interface,
wherein the processor is configured to detect use of the computer application on the user-application interface, and
wherein the informative effects engine is configured to make an informative presentation on select features and functions of the computer application on the user-application interface using the pre-defined informative effects in response to the detected use of the computer application.

2. The computer-based system of claim 1, wherein the pre-defined informative effects on the user-application interface include one or more of audio effects, visual effects, textual effects, graphical effects, static effects, and dynamic movie effects.

3. The computer-based system of claim 1, wherein the scripts for displaying pre-defined informative effects include XML files.

4. The computer-based system of claim 1, wherein the detected use of the computer application is a launch of the computer application that brings up a starting screen of the computer application on the user-application interface, and wherein the informative effects engine is configured to present an overview tutorial of features and functions of the application with informative effects sequentially highlighting one or more parts of the application on the user-application interface.

5. The computer-based system of claim 1, wherein the detected use of the computer application is use of a specific feature or function of the computer application, and wherein the informative effects engine is configured to make a contextual presentation with one or more informative effects highlighting the specific feature or function of the computer application used on the user-application interface.

6. The computer-based system of claim 5, wherein the contextual presentation includes one or more informative effects illustrating application capabilities and options for the specific feature or function of the computer application used on the user-application interface.

7. The computer-based system of claim 1, wherein features and functions of the computer application are represented by graphical objects having respective object identifiers on the user-application interface, and wherein the informative effects engine is configured to register, with the application, object identifiers for the graphical objects representing the one or more features or functions of the computer application for which there are scripts for displaying pre-defined informative effects on the user-application interface.

8. The computer-based system of claim 7, wherein the application is configured to pass a registered object identifier upon detection on the user-application interface back to the informative effects engine to trigger an informative effects presentation on the user-application interface.

9. A computer-implemented method performed by causing at least one processor to execute instructions recorded on a computer-readable storage medium, the computer-implemented method comprising:
interfacing an informative effects engine with a computer application;
detecting an operation of a select feature or function of the computer application on a user-application interface; and
in response to the detection, presenting a tutorial with one or more informative effects related to the select feature or function of the computer application on the user-application interface.

10. The computer-implemented method of claim 9, wherein interfacing an informative effects engine with the computer application includes interfacing an informative effects engine having a set of XML scripts for pre-defined informative effects corresponding to one or more particular features or functions of the computer application.

11. The computer-implemented method of claim 10, wherein the one or more pre-defined informative effects include one or more of audio effects, visual effects, textual effects, graphical effects, static effects, and dynamic movie effects.

12. The computer-implemented method of claim 10, wherein interfacing an informative effects engine with the computer application includes:
registering object identifiers of graphical objects representing the one or more particular features or functions on the user-application interface with the computer application.

13. The computer-implemented method of claim 9, wherein detecting an operation of a select feature or function of the computer application on a user-application interface includes:
detecting an object identifier associated with a graphical object that represents the select feature or function on the user-application interface; and
passing the detected object identifier to the informative effects engine to trigger the presenting of one or more informative effects related to the computer application.

14. The computer-implemented method of claim 13, wherein detecting an object identifier associated with a graphical object that represents the select feature or function on the user-application interface includes:
detecting an object identifier associated with a workflow object.

15. The computer-implemented method of claim 9, wherein presenting a tutorial with one or more informative effects related to the select feature or function of the computer application on the user-application interface includes:
presenting informative effects for a group of one or more graphical objects including the graphical object that represents the select feature or function on the user-application interface and graphical objects representing features or functions of the computer application related to user operation of the select feature or function on the user-application interface.

16. The computer-implemented method of claim 9, wherein presenting informative effects for a group of one or more graphical objects includes:
presenting informative effects for the graphical objects one-by-one in a time sequence.

17. The computer-implemented method of claim 9, wherein presenting informative effects for a group of one or more graphical objects includes:
visually highlighting each of the graphical objects on the user-application interface; and
displaying informative text for highlighted graphical object on the user-application interface.

18. A computer-program product embodied in a non-transitory computer-readable medium that includes executable code, which when executed:
interfaces an informative effects engine with a computer application;
detects an operation of a select feature or function of the computer application on a user-application interface; and
in response to the detection, presents a tutorial with one or more informative effects related to the select feature or function of the computer application on the user-application interface.

19. The computer-program product of claim 18, wherein the executable code when executed interfaces an informative effects engine having a set of XML scripts for pre-defined informative effects corresponding to one or more particular features or functions of the computer application.

20. The computer-program product of claim 19, wherein the executable code when executed registers object identifiers of graphical objects representing the one or more particular features or functions on the user-application interface for which there are XML scripts for pre-defined informative effects with the computer application.
